(19) United States
(12) Patent Application Publication
(10) Pub. No.: US 2003/0231184 A1
(43) Pub. Date: Dec. 18, 2003

(54) Directory listings white space reduction method, apparatus, and system

(76) Inventor: Darin V. Gurney, Provo, UT (US)

Correspondence Address: Brian C. Kunzler, Suite 425, 10 West 100 South, Salt Lake City, UT, 84101, US

(21) Appl. No.: 10/421,069

(22) Filed: Apr. 22, 2003

Related U.S. Application Data
(60) Provisional application No. 60/374,387, filed on Apr. 22, 2002.

(51) Int. Cl. G09G 5/00

(52) U.S. Cl. 345/581

(57) ABSTRACT

A method and system for reducing the white space of published directories while maintaining readability may utilize one or more of a number of techniques. The techniques may include horizontally scaling words to avoid line breaks, reducing the leading when full-height fields do not horizontally overlap the text of the previous line, further reduction of the leading in the absence of descending characters, and selecting the most readable alternate spelling that avoids line breaks. The aforementioned techniques are applied judiciously in order to not disturb perceptible repetitive patterns and to maintain the proportions of proportional fonts.

### BACKGROUND OF THE INVENTION

1. The Field of the Invention

The invention relates to methods and systems for reducing white space while maintaining readability. Specifically, the invention relates to methods, and systems for white space reduction of directory listings.

2. The Relevant Art

Directory listings, such as listings within white pages and yellow pages, are often published at a direct loss to the publisher in order to sell advertising and enhanced listings to businesses, and the like. Consequently, directory publishers are typically highly motivated to reduce the page count of listings in order to reduce publishing costs. Directory users and advertisers, on the other hand, typically prefer large readable listings that are consistent in appearance and facilitate easy access to valuable information over smaller listings that are more difficult to read and use.

Standard directory publishing and typesetting methods use a leading or line spacing that is selected to prevent collisions between descenders and ascenders of adjacent lines and to present readable listings to the directory user. Directory entries may contain a variety of fields such as name fields, address fields, phone number fields that must be formatted in a consistent style to maintain readability and visual appeal. Some fields may further contain sub-fields such as city, state, and zip code sub-fields within an address field. The combination of fields may result in listings that are quite lengthy.

Directory entries often contain line breaks in order to present the listing within a prescribed column width. Line breaks are desirable in some instances, for example in conjunction with an enhanced listing paid for by a customer, and undesirable in other instances in that additional space is required for an entry. The distinction between desirable and undesirable line breaks is often characterized as an essential or non-essential line break. Essential line breaks must be included in the formatted text, while non-essential line breaks may be eliminated at the discretion of the directory producer.

From the above discussion, it is apparent that a methodology is needed to reduce the page count of directory listings while maintaining readability. More specifically, what is needed is a method, apparatus, and system that recognizes when the standard leading may be reduced and when line breaks may be eliminated such that the readability and appearance of directory listings is not degraded. Such an apparatus, method, and system would provide compacted directory entries that are consistent in appearance and highly readable.

### SUMMARY OF THE INVENTION

The present invention has been developed in response to the present state of the art, and in particular, in response to the problems and needs in the art that have not yet been fully solved by currently available directory publishing methods and systems. Accordingly, it is an overall object of the present invention to provide an improved method, apparatus, and system for compacting directory listings while maintaining readability.

To achieve the foregoing object, and in accordance with the invention as embodied and broadly described herein, an improved method, apparatus, and system are presented for reducing white space within directory listings. The improved method, apparatus, and system facilitate a reduced page count and/or enhanced readability of published directories.

In one aspect of the present invention, a method for reducing white space within published directories includes reducing a leading on selected lines and horizontally compacting selected characters to avoid line breaks. The selected lines may include lines whose full-height fields do not horizontally overlap with text on a previous line. The method may also include additional leading reduction in instance where a previous line has no descending characters.

Horizontal compaction of selected characters to avoid line breaks may be accomplished by substituting alternate spellings that are shorter in length than the original spelling. For example, alternate spellings for a street name, or the like, may be substituted for the original spelling in order to eliminate non-essential line breaks. In one embodiment, a most readable spelling, such as the longest spelling, that results in elimination of a non-essential line break is selected from a table of alternate spellings.

The method for reducing white space may further include identifying adjacent lines having descending characters on a first line that collide with ascending characters on a second line and scaling selected characters to avoid the collisions. In one embodiment, the selected characters are characters to the left of a collision point that have not been scaled. In another embodiment, the selected characters are characters from a previous ascending character to the collision point. In yet another embodiment, the selected characters comprise all the characters of a field.

In another aspect of the present invention, an apparatus for publishing directories with reduced white space includes a leading reduction module configured to reduce the leading on selected lines. The leading reduction module may also be configured to further reduce the leading when a previous line has no descending characters. The aforementioned apparatus also includes a horizontal compaction module configured to horizontally compact selected characters to avoid line breaks.

The apparatus may also include a spelling substitution module configured to substitute alternate spellings and a collision detection module configured to identify adjacent lines having descending characters on a first line that collide with ascending characters on a second line. The apparatus for publishing directories with reduced white space facilitates intelligent compaction of entries within a directory listing.

In another aspect of the present invention, a system for publishing directories with reduced white space includes a formatter configured to initially format directory entries and a white space reduction module configured to reduce a leading on selected lines. In certain embodiments, the white space reduction module is further configured to horizontally compact selected characters to avoid line breaks. The system for publishing directories may also include a press configured to print the formatted directory entries.

The present invention facilitates converting non-compacted entries into compacted directory entries that reduce the required printing space for many entries by reducing the leading in a casually imperceptible manner. Furthermore, the present invention employs various horizontal compaction methods in order to eliminate non-essential line breaks and thereby reduce the size and cost of a published directory.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a flowchart depicting a white space reduction method of the present invention;

FIG. 2a is a flowchart depicting a horizontal compaction method of the present invention;

FIG. 2b is a flowchart depicting a vertical compaction method of the present invention;

FIG. 3a is a flowchart depicting a need-driven horizontal scaling method of the present invention;

FIG. 3b is an illustration showing before and after views of a sample directory entry processed by the method depicted in FIG. 3a;

FIG. 4a is a flowchart depicting a need-driven character substitution method of the present invention;

FIG. 4b is an illustration showing before and after views of a sample directory entry processed by the method depicted in FIG. 4a;

FIG. 5a is a flowchart depicting a field-based vertical compaction method of the present invention;

FIG. 5b is an illustration showing before, during and after views of a sample directory entry processed by the method depicted in FIG. 5a;

FIG. 6a is a flowchart depicting a descender/ascender interleaving method of the present invention;

FIG. 6b is an illustration showing before and after views of a sample directory entry processed by the method depicted in FIG. 6a;

FIG. 7 is an illustration showing before and after views of a sample directory page processed by one embodiment of the present invention.

FIG. 8 is a block diagram depicting one embodiment of a white space reduction system of the present invention.

### DETAILED DESCRIPTION OF THE INVENTION

Many of the functional units described in this specification have been labeled as modules, in order to more particularly emphasize their implementation independence. For example, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module of executable code could be a single instruction, or many instructions, and may even be distributed over several different code segments, among different programs, and across several memory devices.

Modules may also be implemented in hardware as electronic circuits comprising custom VLSI circuitry, off-the-shelf semiconductors such as logic chips, transistors, or other discrete components. A module may also be implemented in programmable hardware devices such as field programmable gate arrays, programmable array logic, programmable logic devices or the like.

Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

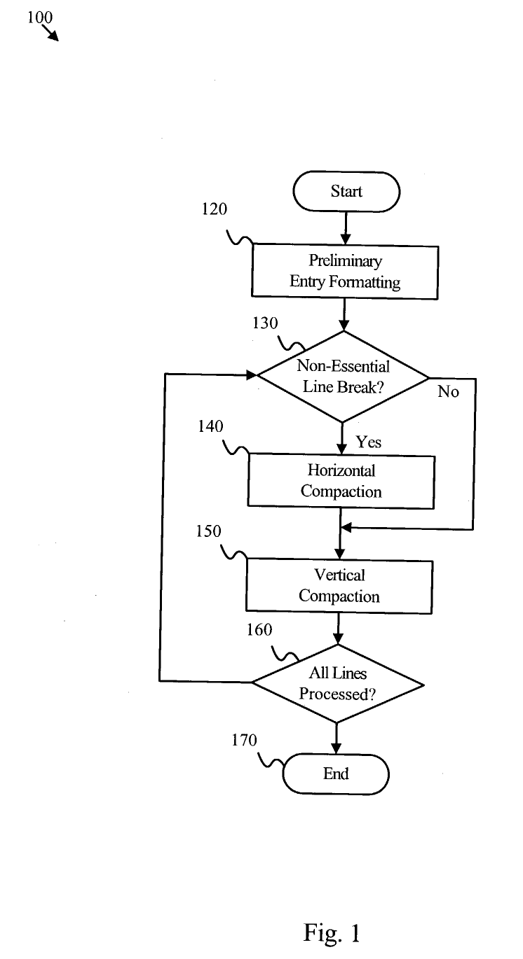

Referring to FIG. 1, a white space reduction method 100 includes a variety of steps sufficient to substantially reduce the page count of printed directories. The method may be applied to raw directory listings stored within text or data files. The method may also be applied to initially formatted directories to reduce the required page count previous to printing. For purposes of clarity, the description herein assumes languages that are typeset from left to right within a line and top to bottom within a page. Appropriate adjustments may be required for adaptation to other typesetting orientations. Not all of the steps of the method 100 need be conducted under the present invention, and of course, additional steps may be added while still falling under the scope of the invention.

The white space reduction method 100 begins with a formatting step 120. The formatting step 120 conducts a preliminary formatting of a directory entry. Directory entries may contain various fields such as a name field, an address field, and a phone number field. The address field may optionally include city, state, and zip code sub-fields.

In one embodiment, a substantial portion of the formatting step 120 is conducted on a directory publisher's computer using standard tools and procedures. In this embodiment, the formatting step 120 also includes reading an entry from a file containing formatted entries. The file may reside on a different computer from that of the publisher such as a computer owned by a printing service bureau. In one embodiment, the formatting step 120 converts a delimited though unformatted entry, such as a line of ASCII text, to an initially formatted entry.

The method 100 proceeds from the formatting step 120 to a line break test 130. The line break test 130 ascertains whether a non-essential line break exists within the initially formatted entry. Essential line breaks include line breaks for special fields, such as a business name field, wherein the customer has paid extra to have the field appear on a separate line. In contrast, non-essential line breaks may be eliminated at the discretion of the directory producer. Entries containing non-essential line breaks cause the white space reduction method 100 to conduct a horizontal compaction step 140. Otherwise the method proceeds directly to a vertical compaction step 150.

The horizontal compaction step 140 attempts to eliminate line breaks by horizontally compacting the entry sufficient to reduce the number of lines in the entry. Various means of compacting may be conducted including character sequence (i.e. spelling) substitutions, horizontal scaling, kerning, tracking, and the like. The horizontal compaction step 140 preferably limits the amount of compaction to casually imperceptible levels in order to maintain readability and aesthetic appeal. Upon completion of the horizontal compaction step 140, the white space reduction method 100 conducts the vertical compaction step 150.

Standard directory publishing and typesetting methods use a leading or line spacing that is selected to prevent collisions between descenders and ascenders of adjacent lines. The present invention intelligently recognizes when the standard leading is not necessary and that the leading may be reduced in a casually imperceptible manner. The vertical compaction methods of the present invention result in compacted directory entries that are consistent in appearance and highly readable.

The vertical compaction step 150 reduces the leading of certain lines such as lines whose full-height fields do not horizontally overlap the text of a previous line, lines wherein the previous line contains no descending characters, and lines containing ascending characters that do not horizontally overlap the descending characters of the previous line. To increase the probability of non-overlapping full height fields as well as descending and ascending characters, some amount of horizontal adjustment or compaction may be conducted. The vertical compaction step 150 is particularly useful in directory listings containing reduced-height fields—a common practice of directory producers and publishers.

Upon completion of the vertical compaction step 150, the white space reduction method 100 conducts a line test 160. The line test 160 ascertains whether all the lines within a directory entry have been processed. If not, the method loops to the line break test 130, otherwise, the method terminates processing at an exit step 170.

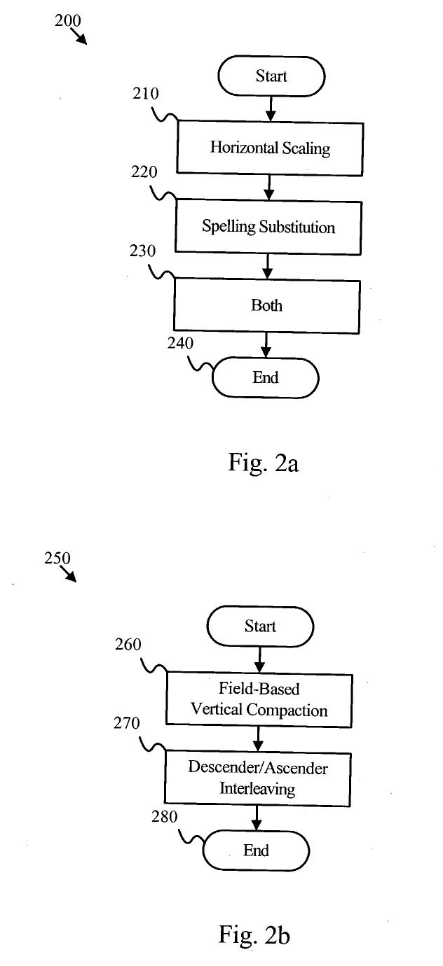

Referring to FIG. 2a, one embodiment of a horizontal compaction method 200 includes a horizontal scaling step 210, a spelling substitution step 220, and a combined step 230. The depicted embodiment is one example of a sequence of tasks that attempt to horizontally compact an entry and thereby reduce the occurrence of line breaks. Execution of each step is dependent on the persistence of non-essential line breaks.

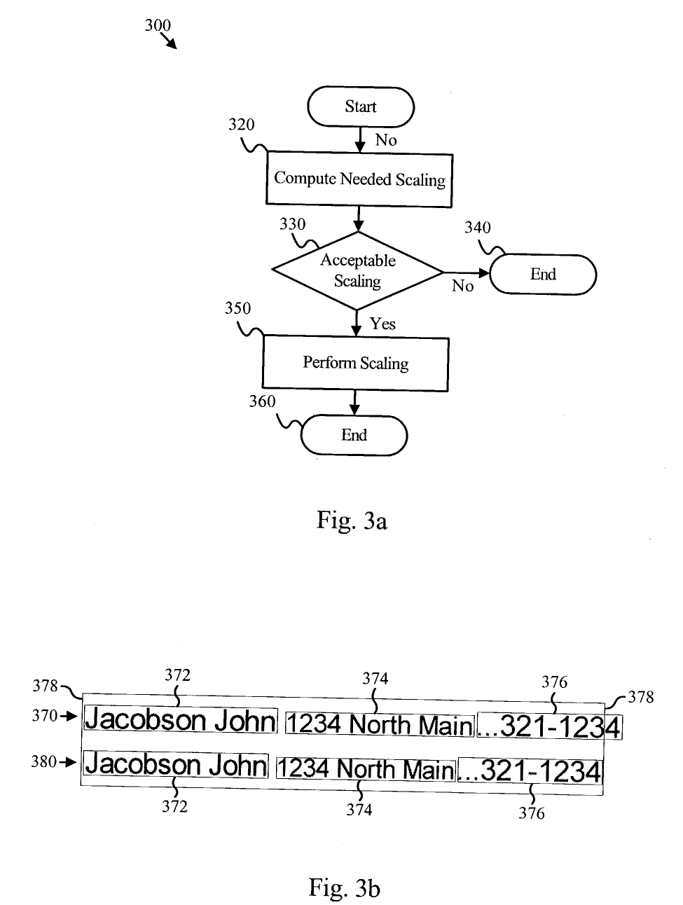

The horizontal scaling step 210 scales selected runs of text to maintain the proportional spacing established by a font designer. The amount of scaling is selected to be sufficient to eliminate non-essential line breaks. One embodiment of the horizontal scaling step 210 will be described in further detail in conjunction with FIGS. 3a and 3b.

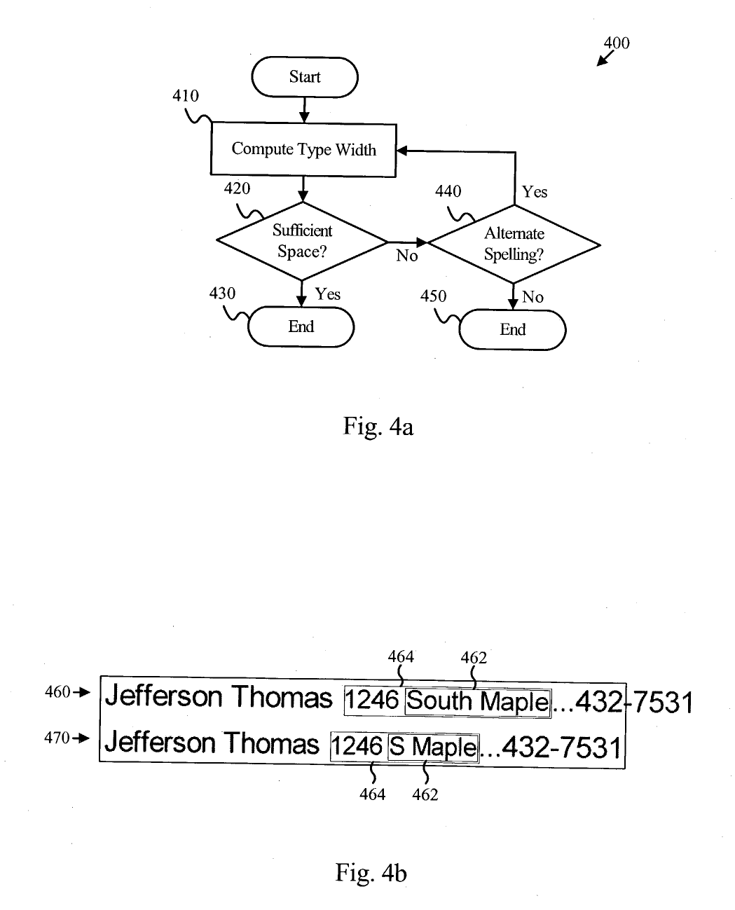

The spelling substitution step 220 replaces selected character sequences with shorter alternate character sequences that retain the desired meaning of the text. The spelling substitution step 220 preferably selects the alternate character sequence that retains the highest degree of readability. The combined step 230 combines the efforts involved with horizontal scaling and spelling substitution to attempt additional compaction when the individual efforts are inadequate. One embodiment of the spelling substitution step 220 will be described in greater detail in conjunction with FIGS. 4a and 4b.

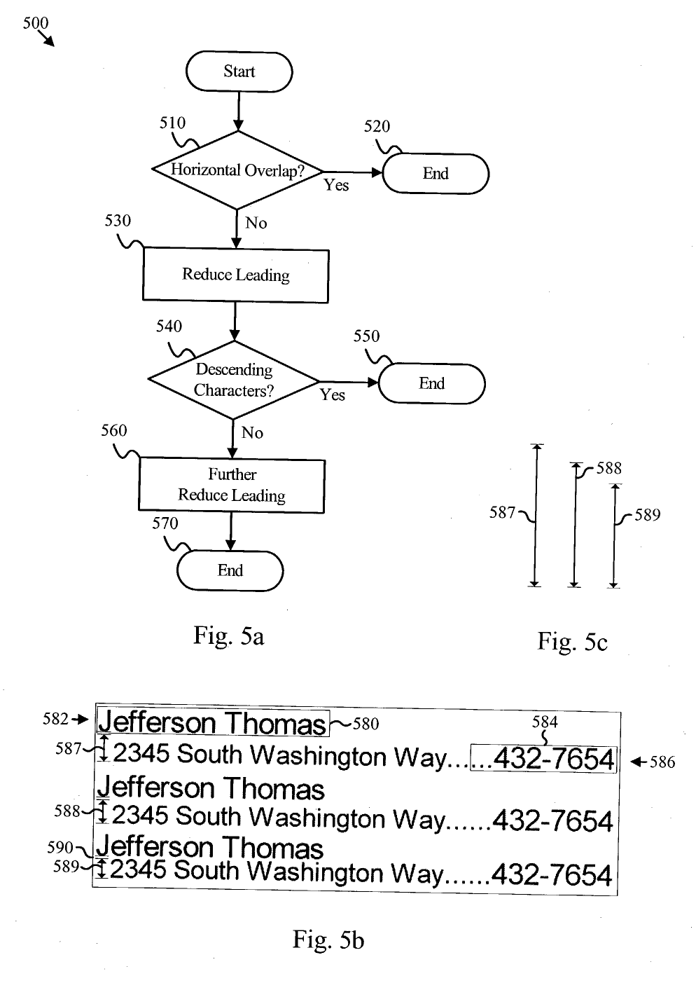

Referring to FIG. 2b, one embodiment of a vertical compaction method 250 includes a field-based compaction step 260 and a descender/ascender interleaving step 270. The field-based compaction step 260 reduces the leading on lines wherein full-height fields such as a phone number field do not horizontally overlap the text of an adjacent previous line. One embodiment of the field-based compaction step 260 will be described in greater detail in conjunction with FIGS. 5a and 5b.

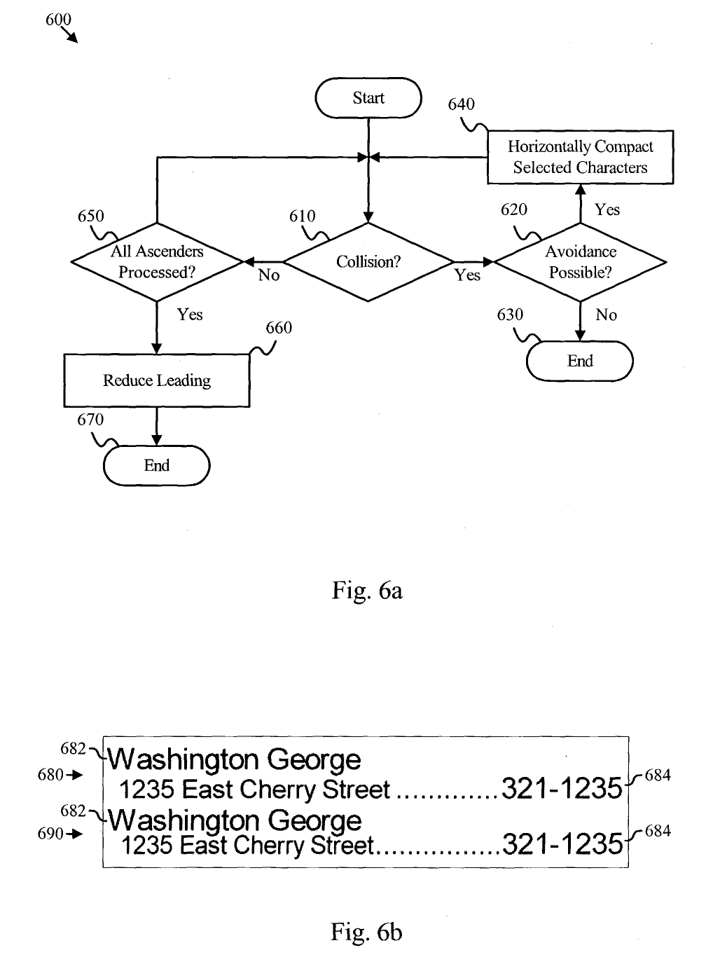

The descender/ascender interleaving step 270 adjusts the placement of characters within one or more lines such that the ascending characters of a line do not horizontally overlap with the descending characters of a preceding line. In one embodiment, adjusting the placement of the characters involves horizontal scaling of selected characters. One embodiment of the descender/ascender interleaving step 270 will be described in greater detail in conjunction with FIGS. 6a and 6b.

Referring to FIG. 3a, a need-driven horizontal scaling method 300 may perform the horizontal scaling step 210. The horizontal scaling method 300 includes a compute need step 320, a scaling test 330, and a scaling step 350. The horizontal scaling method 300 attempts to eliminate line breaks by scaling selected characters or fields to reduce the required type-width.

The compute need step 320 ascertains the amount of horizontal scaling required to eliminate one or more non-essential line breaks. In turn, the scaling test 330 ascertains whether the computed scaling is within acceptable limits. The scaling limits are preferably selected such that the scaling is not perceptible to a casual reader. If the computed required scaling in not within acceptable limits, the horizontal scaling method 300 ends 340. Otherwise the method proceeds to a perform scaling step 350 wherein the actual horizontal scaling is performed. After the perform scaling step 350, the method ends 360.

FIG. 3b shows the utility of the horizontal scaling method 300. An initially formatted directory entry 370 may include a variety of fields such as a name field 372, an address field 374, and a phone number field 376. The initially formatted directory entry 370 may not fit within a column 378. Horizontally scaling a portion or all of the text within the initially formatted directory entry 370 facilitates fitting the entry within the column 378 as shown in a finished directory entry 380. Horizontal scaling is preferably conducted in a manner that retains the relative shape and proportional nature of the fonts used to print or render the text of directory entries.

In the depicted example, the name field 372 and the address field 374 are scaled, while the phone number field 376 is not. Scaling of certain fields or portions thereof is disadvantageous in that perceptually repetitive patterns within the published directory are interrupted resulting in a ragged appearance that reduces readability. Examples of text that is preferably protected from scaling include the phone number field 376, and that portion of the name field which matches the previous entry, if any. Horizontal scaling of well-selected text may significantly reduce the occurrence of line breaks within directory entries while maintaining readability.

FIG. 4a is a flowchart depicting a need-driven character substitution method 400 of the present invention. The character substitution method 400 may perform the spelling substitution step 220. The method includes a compute type-width step 410, a sufficient space test 420, and an alternate test 440. The character substitution method 400 facilitates horizontal compaction of directory entries and elimination of non-essential line breaks.

The compute type-width step 410 computes the type-width required to print a field or a portion thereof. In turn, the sufficient space test 420 ascertains whether enough space is available to print or render the field (or a portion thereof.) In one embodiment, the sufficient space test 420 includes an acceptable level of horizontal scaling in determining whether enough space is available. Preferably, the character substitution method 400 conducts the sufficient space test 420 in conjunction with directory entries containing one or more non-essential line breaks with the intent of eliminating non-essential line breaks. If sufficient space is available, the method ends 430. Otherwise the method conducts the alternate test 440.

The alternate test 440 ascertains whether an alternate character sequence is available that reduces the type-width required to print or render a field or portion thereof. If no alternates are available, the character substitution method 400 ends 450 otherwise the method loops to the compute type-width step 410.

In one embodiment, the alternate test 440 is conducted in conjunction with a substitution table wherein entries comprising character sequences are stored in alphabetical order. Each entry also contains a pointer that references a substitute character sequence. In accordance with the substitution table, conducting the alternate test 440 comprises testing the pointer against a null value indicating that no alternate character sequence is available. Within the described substitution table, multiple alternate character sequences exist as a linked list sorted in type-width order, with the tail member of the list being the shortest possible alternate character sequence.

FIG. 4b is an illustration showing before and after views of a sample directory entry processed by the character substitution method 400. An initially formatted directory entry 460 includes a street field 462 that is a sub-field within an address field 464. In the depicted example, the character substitution method 400 substitutes a shorter character sequence for the street field 462 as shown in a finished directory entry 470. The depicted example also includes an acceptable level of horizontal scaling in order to fit the directory entry within a single line.

FIG. 5a is a flowchart depicting a field-based vertical compaction method 500 of the present invention. The vertical compaction method 500 may perform the field-based compaction step 260. The method includes an overlap test 510, a reduce leading step 530, a descending characters test 540, and a reduce leading further step 570. The vertical compaction method 500 reduces white space by intelligently reducing the leading within selected lines of a directory entry.

Because address fields are typically referenced less often within directories than other fields, using a smaller font for address fields is a typical strategy used within the directory publishing industry. Using a smaller font for address fields saves on publishing space while having a minimal impact on the experience of the user. The present invention leverages the reduced height fields to achieve additional space savings via vertical compaction.

The overlap test 510 ascertains whether horizontal overlap exists between the full-height characters or fields within a line of text such as the phone number field and characters or fields within a preceding line of text such as the name field. If no overlap exists, the vertical compaction method 500 proceeds to the reduce leading step 530. Otherwise, the method ends 520. The reduce leading step 530 reduces the leading to a value appropriate to the tallest reduced-height fields and the characters that overlap with characters or fields of the previous line.

From the reduce leading step 530, the vertical compaction method 500 proceeds to the descending character test 540. The descending character test 540 ascertains whether the preceding line of text contains any descending characters. In one embodiment, the descending character test 540 is further limited to testing that portion of text within the previous line that overlaps with text on the current line.

If descending characters are found, the vertical compaction method 500 ends 550, otherwise the method proceeds to the reduce leading further step 560. The reduce leading further step 560 further reduces the leading on the current line to eliminate the vertical space normally reserved for descending characters. Subsequent to the reduce leading further step 560, the vertical compaction method 500 ends 570.

FIG. 5b is an illustration showing before, during and after views of a sample directory entry processed by the vertical compaction method 500. An initially formatted directory entry includes a name field 580 on a first line 582 and a phone number field 584 on a second line 586. The name field 582 and the phone number field 586 do not overlap horizontally. Consequently, the leading on the second line may be reduced from an initial value 587 to a second value 588. Since the depicted example contains no descending characters in the name field 580, the leading may be further reduced to a final value 589 while maintaining an appropriate interline spacing 590. FIG. 5c shows an enlarged view of the relative sizes of the initial value 587, the second value 588, and the final value 589.

FIG. 6a is a flowchart depicting a descender/ascender interleaving method 600 of the present invention. The descender/ascender interleaving method 600 may perform the descender/ascender interleaving step 270. The descender/ascender interleaving method 600 includes a collision test 610, an avoidance test 620, a horizontal compaction step 640, an ascenders processed test 650, and a reduce leading step 660. The descender/ascender interleaving method 600 facilitates reduction of unneeded interline white space.

The collision test 610 ascertains whether an ascending character on a current line of text (or portion thereof) horizontally overlaps any descending characters on an adjacent preceding line. If not, the method 600 skips the avoidance test 620 and the horizontal compaction step 640, and proceeds to the ascenders processed test 650. If overlap exists, the method loops to the avoidance test 620.

The avoidance test 620 ascertains whether selected characters on the current line of text (or portion thereof) may be horizontally compacted to eliminate the overlap between an ascending character on the current line of text and the overlapping descending characters on the adjacent preceding line. The avoidance test 620 also preferably ascertains or ensures that new collisions will not be introduced. In certain embodiments the avoidance test also ascertains whether horizontal expansion may eliminate the aforementioned overlap.

In a first embodiment, the selected characters comprise the characters to the left of the overlap that have not been compacted. In a second embodiment, the selected characters comprise all characters from a previous ascending character (or the beginning of the line or portion thereof) to the overlap. In the third embodiment, the selected characters comprise all the characters of a field.

The avoidance test 620 preferably limits the considered amount of compaction to casually imperceptible levels. If avoidance within the prescribed limits is not possible, the descender/ascender interleaving method 600 ends 630. If avoidance is possible, the method proceeds to the horizontal compaction step 640. The horizontal compaction step 640 performs sufficient compaction of the selected characters in order to eliminate the overlap. In certain embodiments, the horizontal compaction step 640 may also perform expansion of the selected characters. In one embodiment, the horizontal compaction step 640 comprises the horizontal compaction method 200.

Subsequent to the horizontal compaction step 640, the descender/ascender interleaving method 600 conducts the ascenders processed test 650. The ascenders processed test 650 ascertains whether each ascender within the current line has been processed (tested for collisions). If so, the method proceeds to the reduce leading step 660, otherwise the method loops to the collision test 610.

The reduce leading step 660 reduces the leading on the current line such that the ascenders on the current line overlap vertically without overlapping horizontally. The amount of reduction is selected to maintain readability of directory entries. After the reduce leading step 660, the descender/ascender interleaving method 600 ends 670.

FIG. 6b is an illustration showing before and after views of a sample directory entry processed by the method of FIG. 6a. A directory entry 680 includes a first line 682 and a second line 684 having a reduced leading due to a reduced-height address field 686. The address field 686 is a reduced-height field in that it uses a smaller font than full-height fields.

The depicted directory entry 680 is consistent with an entry processed by the field-based vertical compaction method 500. As depicted with the directory entry 680, the ‘S’ and ‘t’ ascending characters of the second line 684 horizontally overlap the ‘g’ descending character of the first line. The depicted horizontal overlap prevents vertical compaction i.e. leading reduction of the second line 684.

A compacted directory entry 690 features reduced white space while maintaining readable proportional fields. In the depicted compacted directory entry 690, the address field 686 is horizontally scaled sufficient to remove the overlap between the ‘colliding’ characters and thereby facilitate the depicted vertical compaction.

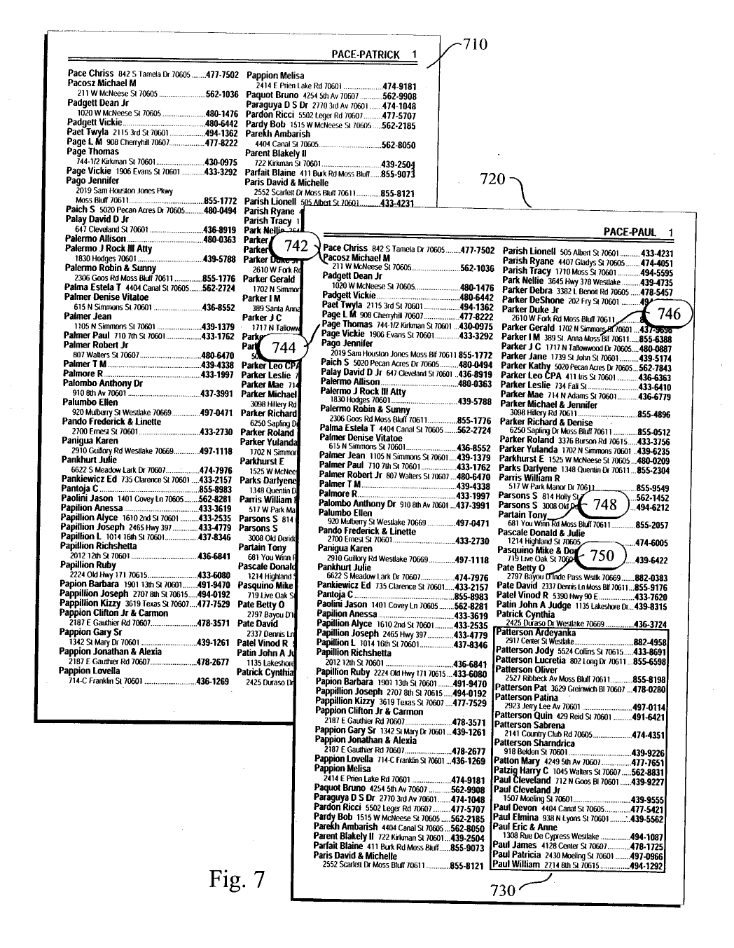

FIG. 7 is an illustration showing before and after views of a sample directory page 710 processed by one embodiment of the present invention. The depicted example highlights the utility of the present invention. As shown, a processed directory page 720 contains additional entries 730 due to the white space reduction techniques of the present invention.

Several examples are highlighted on the processed directory page 720. The leading is reduced on a vertically compacted entry 742 due to the lack of descenders within the first line of text. A horizontally compacted entry 744 fits onto a single line of text via horizontal scaling of the address field. In similar fashion, a horizontally compacted entry 746 uses an alternate spelling of the street address to fit onto a single line. Vertically compacted entries 748 and 750 use descender/ascender interleaving to facilitate leading reduction.

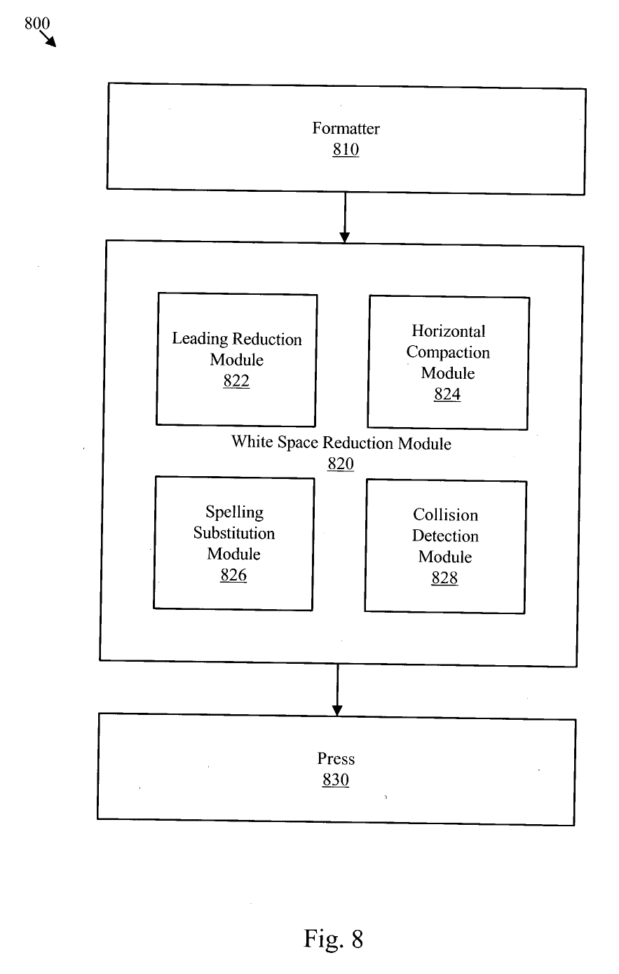

FIG. 8 is a block diagram depicting one embodiment of a white space reduction system 800 of the present invention. The depicted white space reduction system includes a formatter 810, a white space reduction module 820, and a press 830. The depicted white space reduction module further includes a leading reduction module 822, a horizontal compaction module 824, a spelling substitution module 826, and a collision detection module 828.

The leading reduction module 822 computes the amount of leading reduction that may be conducted on a line while maintaining the aesthetic appearance and readability of the directory entries. In one embodiment, the leading reduction module reduces the leading while maintaining repetitive spacing patterns that enhance the readability of a directory and provide a visually appealing appearance.

The horizontal compaction module 824 conducts horizontal compaction operations on directory entries in order to eliminate non-essential line breaks. In certain embodiments, the spelling substitution module 826 is used in conjunction with the horizontal compaction module in order to generate alternate spellings that eliminate non-essential line breaks while maintaining readability of the entry.

The collision detection module 828 detects collisions between descending and ascending characters of adjacent lines. In one embodiment, the collision detection module 828 is used by the leading reduction module to detect when horizontal scaling operations may be used to eliminate collisions and thereby reduce the leading between adjacent lines of text.

The present invention facilitates converting non-compacted directory listings into compacted listings that reduce the page count and cost of a published directory. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for reducing white space within published directories, the method comprising:
reducing a leading on selected lines; and
horizontally compacting selected characters to avoid line breaks.

2. The method of claim 1, wherein the selected lines comprise lines whose full-height fields do not horizontally overlap with text on a previous line.

3. The method of claim 2, wherein the full-height fields comprise a name field and a phone number field.

4. The method of claim 1, wherein the leading is further reduced when a previous line has no descending characters.

5. The method of claim 1, wherein compacting selected characters is selected from the group consisting of scaling selected characters, kerning selected characters, and tracking selected characters.

6. The method of claim 1, wherein compacting selected characters comprises substituting alternate spellings.

7. The method of claim 6, wherein substituting alternate spellings comprises selecting a most readable spelling.

8. The method of claim 1, the method further comprising creating a substitution table containing alternate spellings.

9. The method of claim 1, further comprising:
identifying adjacent lines having descending characters on a first line that collide with ascending characters on a second line; and
scaling selected characters to avoid the collisions.

10. The method of claim 1, wherein the selected characters are characters to the left of a collision point that have not been scaled.

11. The method of claim 1, wherein the selected characters comprise characters from a previous ascending character to a collision point.

12. The method of claim 1, wherein the selected characters comprise all the characters of a field.

13. An apparatus for publishing directories with reduced white space, the apparatus comprising:
a leading reduction module configured to reduce a leading on selected lines; and
a horizontal compaction module configured to horizontally compact selected characters to avoid line breaks.

14. The apparatus of claim 13, wherein the leading reduction module is further configured to further reduce the leading when a previous line has no descending characters.

15. The apparatus of claim 13, further comprising a spelling substitution module configured to provide alternate spellings.

16. The apparatus of claim 13, further comprising a collision detection module configured to identify adjacent lines having descending characters on a first line that collide with ascending characters on a second line.

17. A system for publishing directories with reduced white space, the system comprising:
a formatter configured to initially format directory entries;
a white space reduction module configured to reduce a leading on selected lines; and
the white space reduction module further configured to horizontally compact selected characters to avoid line breaks and thereby provide formatted directory entries.

18. The system of claim 17, further comprising a press configured to print the formatted directory entries.

19. The system of claim 17, wherein the white space reduction module is further configured to reduce the leading on lines whose full-height fields do not horizontally overlap with text on a previous line.

20. The system of claim 17, wherein the white space reduction module is further configured to further reduce the leading when a previous line has no descending characters.

21. The system of claim 17, wherein the white space reduction module is further configured to selectively substitute alternate spellings to avoid line breaks.

22. The system of claim 17, wherein the white space reduction module is further configured to:
identify adjacent lines having descending characters on a first line that collide with ascending characters on a second line; and
scale selected characters to avoid the collisions.
